(19) United States
(12) Patent Application Publication
(10) Pub. No.: US 2007/0092414 A1
(43) Pub. Date: Apr. 26, 2007

(54) Apparatus for odour removal from an input gas

(76) Inventor: Raymond Thomas Malyon, Surrey (GB)

Correspondence Address: Andrew B Morton;Renner Kenner Greive Bobak Taylor & Weber, First National Tower, Fourth Floor, Akron, OH, 44308-1456, US

(21) Appl. No.: 10/570,182

(22) PCT Filed: Sep. 1, 2004
(86) PCT No.: PCT/GB04/03712

§ 371 Date: Sep. 29, 2006

(30) Foreign Application Priority Data
Sep. 1, 2003 (GB) 03204463.3

(51) Int. Cl. B01J 19/12

(52) U.S. Cl. 422/186.3

(57) ABSTRACT

An apparatus for removing unpleasant odour by means of a first section (10) through which the input gas is constrained to travel and which treats the input gas by means of producing ozone from the air in the input gas and a second section (11) which converts into oxygen any remaining ozone in the air stream issuing from the first section. Preferably, the means of producing ozone in the first section is ultra-violet light of a first wavelength and the means for producing ozone in the second section is ultra-violet light of a different wavelength.

The present invention relates to the removal of unpleasant odours from an input gas.

In the past, removal of odours from input gas has often required the use of charcoal filters and while this is an effective technique in many circumstances, it is not suitable for use in all circumstances.

It is an object of the present invention to provide apparatus which will remove unpleasant odours from an input gas stream without the use of filters or any charged plates.

The present invention provides an apparatus for removing unpleasant odours by means of a first section through which the input air is constrained to travel and which treats the input gas by means of producing ozone from the air in the input gas and a second section which converts into oxygen any remaining ozone in the air stream issuing from the first section.

Preferably, ultraviolet light is used in order to create ozone in the first section and ultraviolet light at a different wavelength to the first mentioned ultraviolet is utilised to convert ozone to oxygen in the second section.

Preferably the ultraviolet light in the first section is at 185 nanometers and the ultraviolet light in the second section is at 254 nanometers wavelength.

In order that the present invention be more readily understood, an embodiment thereof will now be described with reference to the accompanying drawings in which:

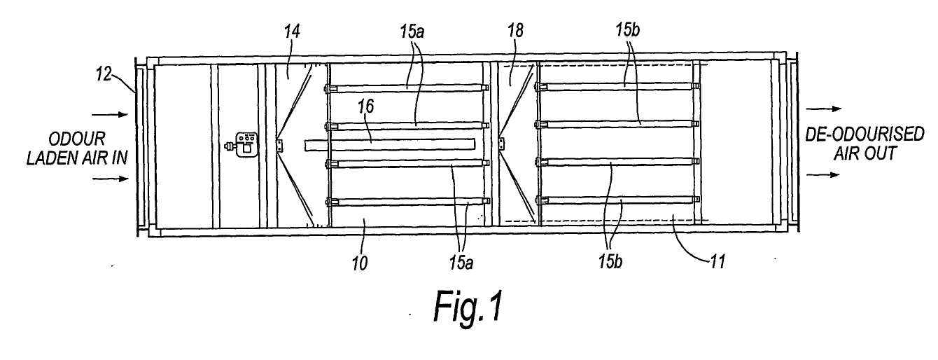

FIG. 1 shows a diagrammatic cross-section through apparatus according to the present invention; and

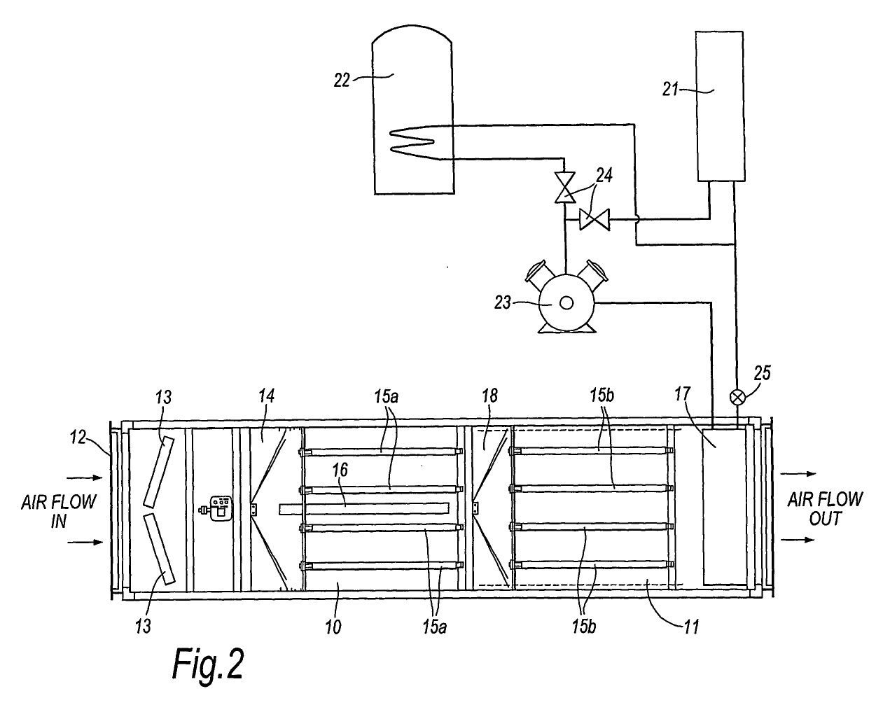

FIG. 2 shows a modification of the apparatus shown in FIG. 1.

Referring to FIG. 1, the apparatus according to the preferred embodiment consists of two sections 10 and 11 respectively. In the first section 10, odour laden air is supplied to an inlet 12 and on entry into the section 10 the air is irradiated by ultraviolet light at a wavelength suitable to produce ozone. In this case it has been found that ultraviolet light at a wavelength of 185 nanometers is appropriate. The ultraviolet light is provided by a plurality of UV lamps 15a which are positioned in parallel and equidistant from each other within the first section 10. In this way, the air obtains the same exposure to the ultraviolet radiation.

In order to promote the creation of ozone, the air passing through the inlet 12 is subjected to means for creating a diffuse, turbulent air flow and this is represented by two air turbulators 14. The turbulators form the air into a circular vortex. Additionally, a catalyst is provided within the section 10 to promote the production of ozone. In this embodiment the catalyst is in the form of a titanium dioxide coated metal sheet 16 which is located centrally in the section 10.

Within the section 10, due to the action of the UV light, some of the oxygen (O₂) within the odour laden air stream is broken down into single oxygen atoms. These atoms attach themselves to a complete oxygen (O₂) molecule which then forms ozone (O₃). The ozone thus produced breaks down the odour-forming compounds in the input air stream by oxidation.

The partially treated air exiting the section 10 is passed into the second section 11 where any residual ozone is removed. This is achieved by illuminating the air flowing through the section 11 with ultraviolet light at a suitable wavelength to convert the ozone into single atoms which in turn revert back to complete oxygen molecules. In the present embodiment this is achieved by using UV light at a wavelength of 254 nanometers. As in the first section 10, the ultraviolet light is provided by a plurality of UV lamps 15b which Are arranged in a similar configuration to the first section 10. The process in the section 11 is enhanced by lining the section with a highly reflective surface such as may be provided by an aluminium alloy sold under the trade name Alanod.

The air output from the section 11 is odourless and also contains no ozone so it can be safely discharged to atmosphere or into any controlled environmental space.

If desired, the air leaving the section 10 can be subjected to turbulation prior to entry into section 11 by utilising turbulators 18. Further, baffles which may be either stationary or moveable may be provided within either or both sections 10 and 11 in order to maintain the turbulent flow of air through the sections.

The ultraviolet light can be produced by conventionally available UV lamps and they may be contained within one or more airtight/light tight casings with protective devices to prevent the accidental exposure of personnel to ultraviolet light.

The odour control apparatus described above is an ultraviolet based system that results in complete removal of odorous compounds from the air. The unit can be designed as either a section to be mounted within an existing air handling plant or as a free standing, self contained unit complete with its own air moving device.

FIG. 2 shows a modification to the present invention whereby the odour removal apparatus is combined with a refrigeration circuit of an energy recovery system to enable heat energy to be recovered from the clean exhausted air after odour removal.

Referring to FIG. 2, the odour removal apparatus 1 is provided with an evaporator in the form of a heat recovery coil 17 which is mounted in the discharge of the odour removal apparatus.

In addition, a pair of unit air filters 13 are disposed between the inlet 12 and the first section 10. These may be in the form of washable polyester foam or grease filters.

The exhaust air from the odour removal system is mechanically cooled by refrigeration. Both sensible and latent energy is removed which in turn is deposited into one side 21 of the recovery system 2 which is an air system to provide space heating.

If predetermined conditions are satisfied then the recovered energy can be deposited into a second side 22 of the recovery system 2 which is a hot water tank to provide domestic hot water to a building.

During periods when both elements of the recovery system are near satisfied then by regulating the flow of refrigerant gas, temperature of the air and water can be regulated so that both air and water can be heated simultaneously.

The energy recovery process employed by the combined system will now be described in more detail by referring to the elements of the energy recovery system 2 shown in FIG. 2.

Vapour compression is employed to provide the cooling effect within the exhaust air and the heating effect in the recovery system 2.

Starting at a compressor 23 discharge where the temperature of a refrigerant gas has been elevated by mechanical compression. The hot gas passes through condensers where heat energy is removed and is passed into either an air 21 or water system 22. Control valves 24 are arranged between the compressor 23 and the air and water system 21, 22 to automatically change priority from air to water if desired. After passing through the air and/or water system 21,22 the high pressure cooled refrigerant liquid passes through an expansion valve 25 through which the fluid pressure is lowered. The low-pressure fluid enters the evaporator 17 of the odour control system where it evaporates by absorbing heat from the exhaust air. The warmed gas re-enters the compressor 23 and the whole cycle is repeated.

A system temperature control unit (not shown) continually monitors the conditions within both of the recovered heat energy systems and the exhaust air from the odour removal system. In this way the most beneficial energy recovery can be achieved.

In addition to the above mechanical cooling can be provided to the treated space by a system of refrigerant reversing valves. Converting the evaporator into a condenser and the condenser into an evaporator.

In this way the combined system will enable odorous compounds to be removed from the air and also enable surplus energy contained within the exhausted air to be recovered and transferred to another medium, for example a ventilation system serving the building or a hot water storage tank.

This process is of particular use when applied for example to a kitchen exhaust system. As the recovered energy will provide economical pre-heating to the hot water system of the kitchen or indeed any area within a building.

1. An apparatus for removing unpleasant odours from an input gas comprising:
a first section (10) through which the input gas is constrained to travel and which treats the input gas by means of producing ozone from air in the input gas; and
a second section (11) which converts into oxygen any remaining ozone in the air stream issuing from the first section.

2. The apparatus according to claim 1 wherein ultra-violet light of a first wavelength is used in order to create the ozone in the first section and ultra-violet light at a different wavelength to the first wavelength is utilised to convert ozone to oxygen in the second section.

3. The apparatus according to claim 2 wherein the ultra-violet light in the first section is a 185 nanometers and the ultra-violet light in the second section is at 254 nanometers wavelength.

4. The apparatus according to claim 2 wherein the ultraviolet light is provided by a plurality of lamps (15a, 15b) which are positioned in parallel to each other and equidistant from each other within each section (10, 11) of the chamber.

5. The apparatus according to claim 1 wherein a catalyst is provided within the first section to promote the production of ozone.

6. The apparatus according to claim 5 wherein the catalyst is in the form of a titanium dioxide coated metal sheet (16) located centrally in the first section.

7. The apparatus according to claim 1 wherein the second section is lined with a highly reflective surface.

8. The apparatus according to claim 7 wherein the highly reflective surface is an aluminium alloy.

9. The apparatus according to claim 1 further comprising at least one baffle arranged to maintain air flow in the apparatus.

10. The apparatus according to claim 1 further comprising a heat recovery coil (17) mounted adjacent to the second section in order to recover heat energy from the exhaust air.
